(19) United States
(12) Patent Application Publication
(10) Pub. No.: US 2009/0013935 A1
(43) Pub. Date: Jan. 15, 2009

(54) EZ-clean litter saver

(76) Inventor: Robert Dean Beck, Corona, CA (US)

Correspondence Address: ROBERT D. BECK, Apt. #105, 571 Wellesley, CORONA, CA, 92879, US

(21) Appl. No.: 11/825,594

(22) Filed: Jul. 9, 2007

(51) Int. Cl. A01K 29/00

(52) U.S. Cl. 119/166

(57) ABSTRACT

Apparatus for receiving and disposing of animal wastes and particularly the bodily wastes of cats, include an upper chamber adapted to sift and separate. An internal sifting screen is mounted to sift there from the accumulated refuse. In another form, the screen is configured to be tilted to pass the litter through the centrally placed screen assembly for the separating of the preferably nonabsorbent litter bed for further use. The apparatus has an external container in which kitty litter will be separated and collected separate from the solid waste, and a removable internal container for the collection of solid waste. Once the solid material is separated from the kitty litter, and drops into the storage container, the cat owner can dispose of the cat waste when desired.

The invention relates to the design of a cat litter-box cleaning device. This device separates cat litter from cat fecal matter and any foreign material that might have been introduced to the cat litter.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Many people consider cats to be an ideal household pet. Cats are owned in many situations, living both indoors and outdoors. In many urban situations, it is unsafe for a cat to be outside due to predators, traffic, and other health related hazards. When a cat is a strictly indoor cat, issues such as excrement must be addressed. The widely used solution is to provide a box (called a “litter-box”) filled with a material that clumps around the excrement and suppresses orders, commonly called “cat litter”, “kitty litter” or simply “litter”.

Litter-boxes must be cleaned frequently and the litter changed regularly to avoid unpleasant odors, and to create a place a cat is willing to defecate. Cleaning litter-boxes is a job that is often messy and unpleasant. Cat feces also pose risk to pregnant women and small children, so avoidance is sometimes necessary. Tools have been created, such as slotted scoops, to assist in the job, but they are often difficult to use, or require great exposure to the fecal matter. Other systems use motorized cleaning systems, which frequently break, require electricity, and often scare the pets in the process. It would be advantageous to have a system that allows cat owners to clean their litter-boxes quickly and with limited exposure to the fecal matter using a simple non-electric system.

### BRIEF SUMMARY OF THE INVENTION

Embodiments of the disclosed invention include a system for quickly and easily cleaning a cat litter-box. The system, referred to as an “EZ-Clean Litter Saver”, requires two cat litter-boxes to complete the process. When the litter needs to be changed, an empty litter-box is placed under the shoot in the “EZ-Clean Litter Saver”. The full box is poured into the hopper, which then filters excrement out, letting the clean litter thoroughly mix and return to the waiting box under the chute.

The fecal matter is then trapped in a screen, which can be emptied by lifting two knobs, dumping the contents into a drawer below. The drawer may be pre-loaded with a bag, such as are used at grocery stores. The bag is then tied off and disposed of.

In this matter, the fecal matter is filtered out, and the cat litter can be reused. The sifting process thoroughly mixes, and aerates the litter, making it last longer.

Additional features and advantages according to the present invention in its various embodiments will be apparent from the remainder of this disclosure.

### BRIEF DESCRIPTION OF THE SEVERAL VIEWS OF THE DRAWING

Features and advantages according to embodiments of the invention will be apparent from the following Detailed Description taken in conjunction with the accompanying drawings, in which:

FIG. 1 shows a side view of the EZ-Clean Litter Saver according to the embodiments of the present invention.

FIG. 2 shows a top view of the EZ-Clean Litter Saver, detailing the hopper, according to the embodiments of the present invention.

FIG. 3 shows a front view of the EZ-Clean Litter Saver, detailing the chute, according to the embodiments of the present invention.

FIG. 4 shows a side view of the EZ-Clean Litter Saver, detailing the screen and chute mechanism, according to the embodiments of the present invention.

FIG. 5 shows a side view of the EZ-Clean Litter Saver with the screen in a dumping position.

### DETAILED DESCRIPTION OF THE DRAWINGS

An innovative method of cleaning cat litter-boxes is described herein.

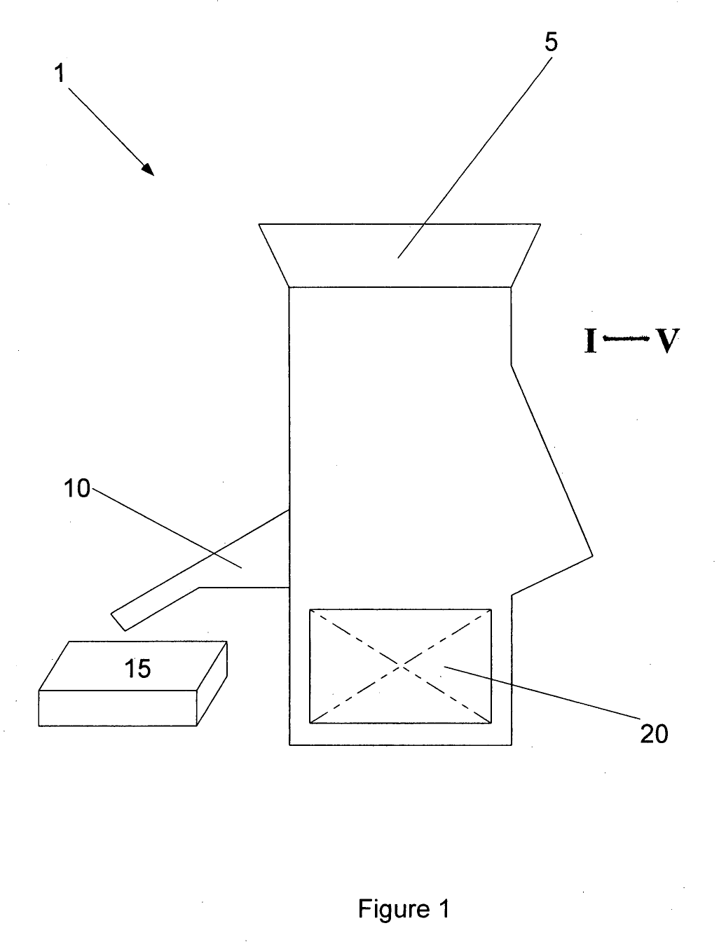

FIG. 1 shows a side view of an EZ-Clean Litter Saver 1, showing the general shape and layout of the invention. The dirty litter is poured into a hopper 5, sifted and separated, with the clean litter coming out of an exit chute 10, into an empty liter-box 15. The excrement is then dumped into a drawer 20, which optionally is lined with a bag, the drawer 20 is removed, and the excrement is disposed of. The contained nature of the EZ-Clean Litter Saver makes a job, which is normally messy, easy, and sanitary.

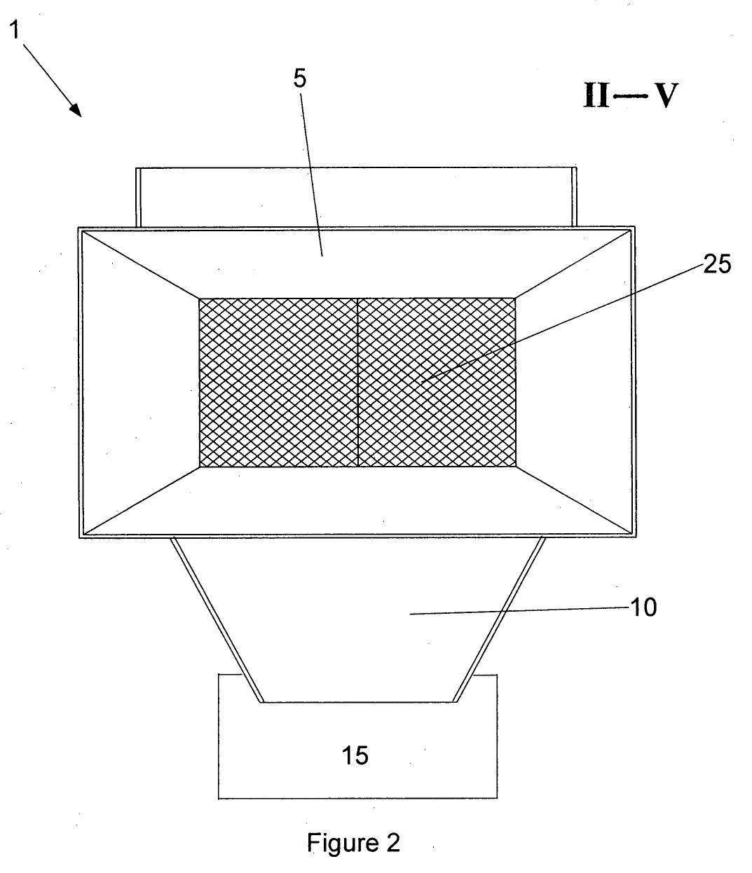

FIG. 2 shows a top view of an EZ-Clean Litter Saver 1. When the dirty litter is poured into the hopper 5, a screen 25 catches the excrement and lets the clean litter flow through. The clean litter flows through and out the exit chute 10 and into the empty litter-box 15. The hopper 5 may be designed large enough that it is easy to pour a full-sized litter-box 15 without worrying about spilling litter and excrement over the sides.

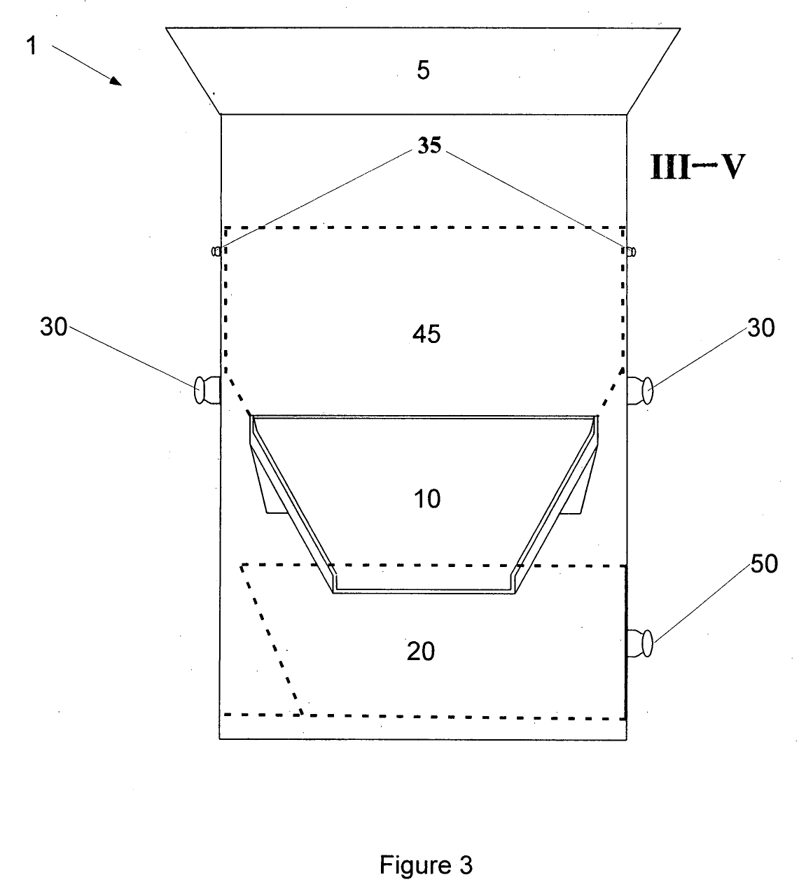

FIG. 3 shows a front view of an EZ-Clean Litter Saver 1, including the hopper 5 and the exit chute 10. One set of knobs 30 is located on the sides. These knobs 30 are used in the screen-dumping process. There is also a pivot point 35 which the screen 25 (see FIG. 2) and an internal chute 40 (not shown in this figure) pivot on. The screen and chute apparatus 45 is located in the area between the pivot point 35 and the knobs 30. The positioning of the drawer 20 and the drawer handle 50 can also be seen. The drawer 20 may be fully removable, making it easier to remove and tie a lining bag.

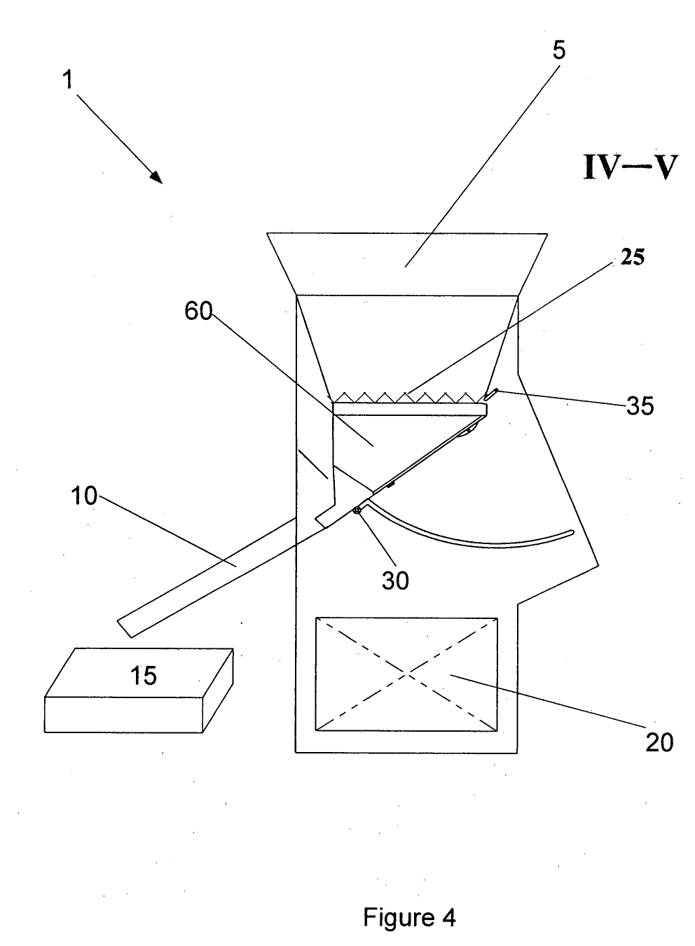

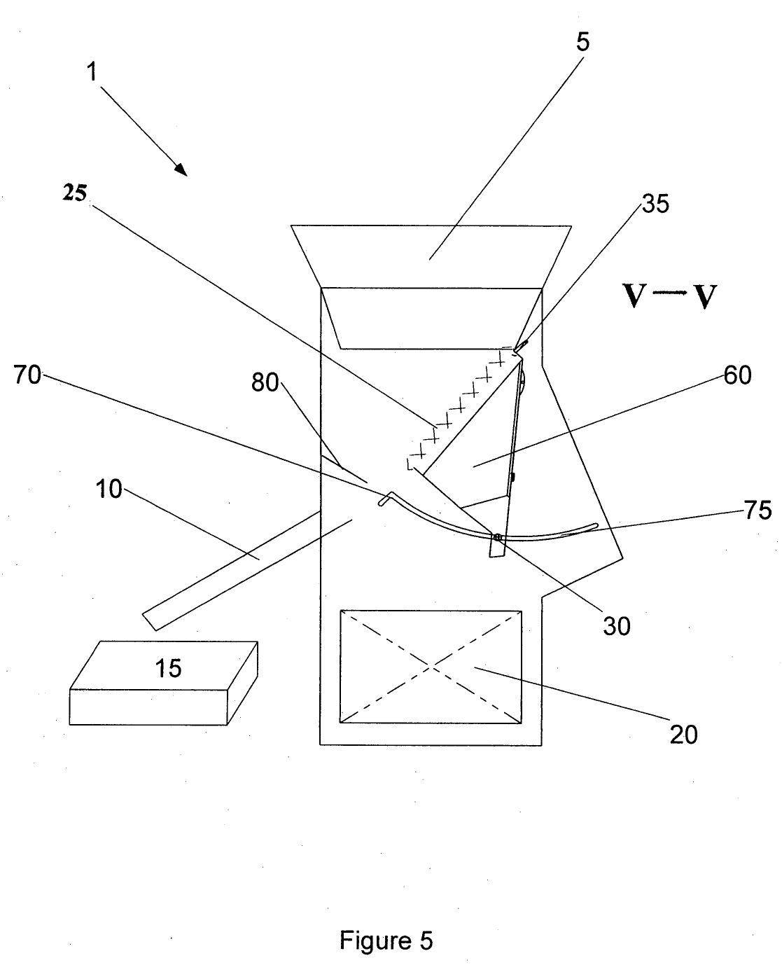

FIG. 4 shows a side view of an EZ-Clean Litter Saver 1, detailing a screen 25 and an internal chute 60 in a closed position. In this position, the dirty kitty-litter is poured into the hopper 5. The kitty-litter filters through the screen 25, into the internal chute 60, into the exit chute 10 and into the empty cat-box 15. The fecal matter is left in the screen 25, until the screen is emptied, as is explained in FIG. 5.

FIG. 5 shows an internal chute 60 in a dumping position. Once the litter is filtered into the empty cat box 15, leaving the fecal matter on the screen 25, the fecal matter is dumped into the drawer 20. This process is completed as is described in the following narrative. To dump the fecal matter, the knob 30 is grasped and lifted upwards to release the internal chute 60 from a slot notch 70 into a main slot 75. This allows the internal chute 60 to drop down, dumping the fecal matter off of the chute 25 and into the drawer 20. The pivot point 35 has sufficient range of motion to allow the lifting motion within the slot notch 70. A deflector 80 is strategically positioned to prevent fecal matter entering the exit chute 10. Once the fecal matter is in the bag-lined drawer 20, the drawer 20 is opened, a bag removed, and the fecal matter disposed of.

Although the internal mechanisms are intricate, the end user doesn't have to interact with anything but a few simple knobs on the outside. The simplicity of the EZ-Clean Litter Saver makes it easy for anybody to clean a litter-box quickly and in a sanitary manner.

The description of specific embodiments herein is for demonstration purposes and in no way limits the scope of this disclosure to exclude other not specifically described embodiments of the present invention.

I claim as my invention:

1. Apparatus for mechanical separation of cat solid waste, randomly buried in cat litter, and cat urine saturated litter clump waste from surrounding clean cat litter and mechanically removing said waste to storage, comprising:
a) the apparatus of claim 1 wherein the container includes walled front, back, sides, and a top with a top flared open portion proximate the front and sides, the front has an open extension for separation of granular material, and the waste collection means being positioned at the base, wherein the first mechanism includes a frame structure including a screened top, walled base, sides, with horizontally hinged end links pivotally connected to the frame structure in the manner of knobs manually actuated to a position that the mechanism is lowered over the collection means in a position that deposits separated solids from the screen into the collection means,
b) a screen member with screening elements spaced to pass the granular material and collect solid waste material typically discharged from a household pet using a litter box, the screen member being positioned over the container positioned at the bottom with actuation and deposit means for actuating the screening of solids from the container,
c) a solid partition extending outwardly from said periphery at a location adjacent to said opening so as to separate granular material called litter on the side opposite of said solid partition from said opening when said opening is in said first rotational position,
d) waste collection means for receiving solids from the container,

2. apparatus of claim 1 wherein the solid collection means comprises a compartment under the bottom of the container adapted to collect and hold solid waste.

3. the apparatus of claim 1 wherein the actuation and deposit means includes a first mechanism having means for passing the screen member through the granular material, separating the solid material from the granular material.

4. the apparatus of claim 3 having a housing structure, on which the first mechanism is mounted, the first mechanism including lift means connected to the screen member for lifting the screen member through the granular material.

5. the apparatus of claim 3 having a screen that retains said solid waste and litter clump waste, said screen extending inwardly from said periphery at a location spaced from said solid partition so as to pass through said litter as said housing is rotated in a manner that causes said opening to move from said first rotational position to said second rotational position.

6. the apparatus of claim 3 whereby when said housing rotates to said second position, said solid waste and litter clumps are automatically discharged through said opening into said waste collection region, said litter is automatically sifted and aerated by passing through said screen, and said litter is retained in said housing.

7. the apparatus of claim 3 wherein the lift means comprises two actuating knobs, and a spindle adapted to rotate the assembly for the displacement of the waste, and connecting slots for positioning means of two locations.

8. the apparatus of claim 3 wherein the screen member is constructed with a back, sides, and a bottom with an open end, and, said container is constructed wherein the manual actuation and deposit means for tilting the container and screen member in a manner adapted to deposit solids from the screen member into the waste collection means.

9. the apparatus of claim 1 wherein the housing includes an area for placement of a removable solid waste storage tray into which the solid waste is dropped upon interaction of the dropping means through opening, including:
a) a frame,
b) an open container supported by said frame for the containment and convenient deposit of refuse,

10. the apparatus of claim 9 further comprising a removable drawer that can be moved into said waste collection region to collect waste falling through said opening and can be removed from said support.
